(19) United States
(12) Patent Application Publication
(10) Pub. No.: US 2012/0135293 A1
(43) Pub. Date: May 31, 2012

(54) BATTERY SET PACKAGE

(75) Inventors: HUAN-LUNG GU, Hualien County (TW); Jyh-Chun Chang, New Taipei City (TW)

(73) Assignee: Industrial Technology Research Institute, Hsinchu (TW)

(21) Appl. No.: 13/034,942

(22) Filed: Feb. 25, 2011

(30) Foreign Application Priority Data
Nov. 29, 2010 (TW) 099141206

(51) Int. Cl. H01M 10/02; H01M 2/02

(52) U.S. Cl. 429/156; 429/176

(57) ABSTRACT

A battery set package is disclosed, which comprises: a plurality of battery cells, each being configured with a frame of a specific length that has two terminals defined at the two opposite longitudinal ends of the frame; two brackets, disposed respectively at the two opposite terminals of the frame for allowing the plural battery cells to be sandwiched between the two brackets; two shells, respectively mounted on the both side of the two brackets; and a plurality of fixtures, for exerting clamping forces in a direction parallel with the longitudinal direction of the frame to the two shells so as to press the two shells to move toward each other and thus fixedly secured the two brackets along with the plural battery cells between the two shells.

### TECHNICAL FIELD

The present disclosure relates to a battery set package, and more particularly, to a battery set package with sandwich structure, by that not only the structural rigidity of the package is enhanced, but also the major portions of the battery cells mounted inside the package are exposed and thus can be cooled down by air flows of natural convection, especially when the battery set package is mounted on a vehicle, the battery cells can be fully cooled down by the wind resulting from the moving of the vehicle without requiring any additional cooling device, and consequently, the battery set package is advantageous in that: the weight of the complete battery set package can be greatly reduced with comparatively smaller space required for installment, and the probability of malfunction is greatly reduced as well as the manufacturing cost is greatly reduced.

### TECHNICAL BACKGROUND

Lithium batteries can provide extremely high currents and can discharge very rapidly when short-circuited. Nevertheless, although this is useful in applications where high currents are required, a too-rapid discharge of a lithium battery can result in overheating of the battery, rupture, and even explosion. Therefore, it is common for the lithium batteries to incorporate thermal protection devices or heat dissipation devices in order to prevent explosion. Moreover, because of the above risks, it is generally not recommended to build an ultra-high-power lithium battery cell, since an ultra-high-power lithium battery cell is usually large in size so that it may not be able to dissipate heat effectively, thereby causing the battery cell to overheat and possibly explode. Thus, for safety consideration, the maximum size of the lithium battery cell to be built is restricted. Consequently, for adapting the lithium battery cells to high-power applications, they are series-connected or parallel-connected so as to form a high-power, high-capacity battery set as the battery voltage is additive when serial connected and the battery current is additive when parallel connected.

It is noted that for enhancing the motor output and endurance of a battery electric vehicle (BEV) to achieve a commonly acceptable cruising range and acceleration, the energy storage density of the battery cells in BEV application mush be increased, i.e. the power as well as the capacity of the battery cell should be increased. However, also under the forgoing restriction, such battery demand in BEV application can only be fulfilled by the use of lithium batteries in series-parallel connection.

Despite the aforesaid battery set that comprises a plurality of battery cells is already pretty heavy, it is required to be packed into a battery set package so as to be mounted on a vehicle. Consequently, not only the structure of the battery set package must be built strong enough for preventing the battery set from loosening in the package due to vibrations of the moving vehicle, but also the battery set package should be built waterproof for preventing any electric leakage from the circuit of the battery set.

The common vehicle-mounted battery set package is constructed as a fully closed structure, using that as all the battery cells are sealed inside the battery set package, the heat generated from those battery cells can only be dissipate either by a water-cooling means, or by the use of a fan unit for withdrawing air out of the sealed battery set package so as to force an airflow of man-made air convection to blow upon the battery cells. However, for receiving all the battery cells therein, as the filly closed battery set package not only should be built larger enough, but also it should be built with sufficient structural rigidity, consequently the weight of the battery set package itself can be very heavy. Moreover, it is noted that the whole battery set package is required to be built differently in size so as to be adapted for package battery cells of different size; and the use of cooling device in the aforesaid battery set package for cooling the battery cells not only may not be cost effective in view of the manufacturing cost and power consumption, but also the malfunction probability of the battery set package is increased since any malfunctioning of the cooling device may cause the temperature of its battery cells to increase rapidly and thus stop discharging. That is, the conventional vehicle-mounted battery set package is disadvantageous in that: the weight of the complete battery set package can be very heavy as the battery set package itself may occupy a comparatively large space for installment; and structure of the battery set package may be very complex with many parts and thus its may be very costly to build; the battery set package is not flexible to be adapted for receiving batteries of different sizes; and the probability of malfunction is high, and so on.

There are two major approaches for improving the aforesaid disadvantages that are known to those skilled in the art. One of which is focused on the improvement of the battery cell itself, favored by the battery manufacturer and industry, that is based on an idea that the overall weight and size of the battery set package can be reduced by building battery cells with increased energy storage density using new materials. Another approach is focused on the packaging of the battery set, that is favored by the battery users including the automobile industry, and is trying to find an innovated battery set package structure that is lighter, smaller and less costly to build under the same specification and quantity of battery cells. Since electric vehicles are becoming the trend of the future, the aforesaid two approaches are in fierce competition with each other as more and more resources are being invested in EV applications.

There are already many studies relating to the improvement of the battery set package, such as those disclosed in U.S. Pat. No. 7,690,464, TW Pat. No. M354528, TW Pat. No. M366407, TW Pat. No. M372796, TW Pat. No. M384780. However, the battery set packages that are improved in those disclosures are still constructed as a fully closed structure, in that a number of battery cells is first being integrated into a battery set, and then the battery set is fitted into a shell of the battery set package while being fixedly secured for preventing the same from moving or vibrating inside the shell and thus being damaged by the collision with the shell, and thereafter, the shell is assembled with a cover so as to sealed the battery set inside the shell. Nevertheless, all the aforesaid battery set packages are still suffered by the same disadvantages of those conventional battery set package, including: the build of the battery set package is heavy and bulky; poor cooling efficiency, high cooling cost, and so on

### TECHNICAL SUMMARY

The present disclosure provides a battery set package with sandwich structure, by that not only the structural rigidity of the package is enhanced, but also the major portions of the batteries mounted inside the package are exposed and thus can be cooled down by air flows of natural convection, especially when the battery set package is mounted on a vehicle, the batteries can be fully cooled down by the wind resulting from the moving of the vehicle without requiring any additional cooling device, and consequently, the battery set package is advantageous in that: the weight of the complete battery set package can be greatly reduced with comparatively smaller space required for installment, and the probability of malfunction is greatly reduced as well as the manufacturing cost is greatly reduced.

The present disclosure further provides a battery set package, comprising:
a plurality of battery cells, each being configured with a frame of a specific length that has two terminals defined at the two opposite longitudinal ends of the frame;
two brackets, each being configured with a first side and a second side that are opposite to each other, the two brackets being disposed respectively at the two opposite terminals of the frame for allowing the plural battery cells to be sandwiched between the two first sides of the two brackets;
two shells, respectively mounted on the second sides of the two brackets while allowing the two bracket having the plural battery cells sandwiched therebetween to be sandwiched between the two shells; and
a plurality of fixtures, for exerting clamping forces in a direction parallel with the longitudinal direction of the frame to the two shells so as to press the two shells to move toward each other and thus fixedly secured the two brackets along with the plural battery cells between the two shells.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is an exploded view of a battery set package according to a first embodiment of the present disclosure.

FIG. 2 is a three-dimensional view of the battery set package of FIG. 1.

FIG. 3 is a schematic diagram showing a bolt used in the present disclosure that is capable of acting as a spacer.

FIG. 4 is a schematic diagram showing a spacer according to an embodiment of the present disclosure.

FIG. 5 is a schematic diagram shown another battery cell being used in the present disclosure.

FIG. 6 is a three-dimensional view of a battery set package according to another embodiment of the present disclosure.

FIG. 7 is a schematic diagram showing how the battery set package of FIG. 6 can be mounted on a vehicle frame.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

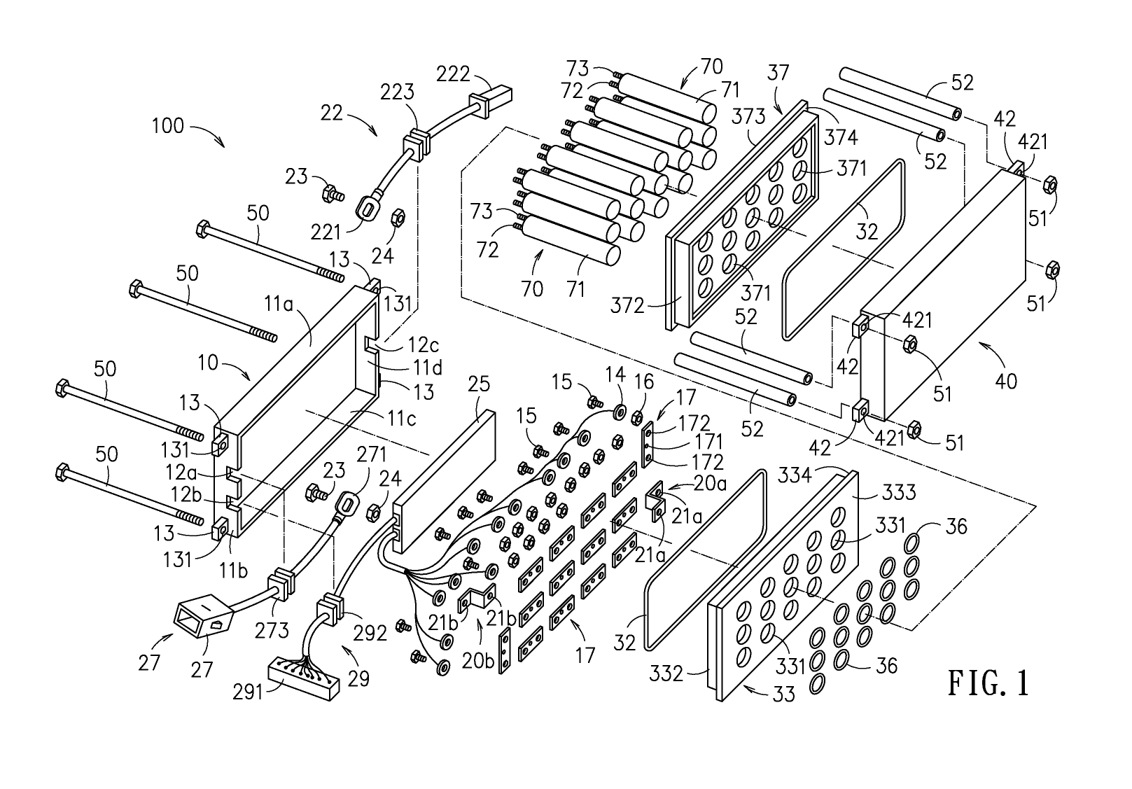

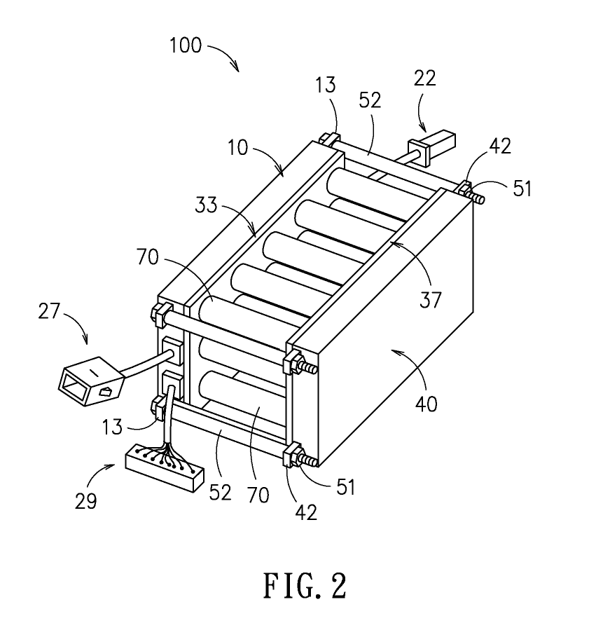

Please refer to FIG. 1 and FIG. 2, which show a battery set package according to a first embodiment of the present disclosure. As shown in FIG. 1 and FIG. 2, the battery set package 100 comprises: a plurality of battery cells 70, a first bracket 33, a second bracket 37, a first shell 10 and a second shell 40, in which the plural battery cells 70 are sandwiched and hold between the first bracket 33 and the second bracket 37, while the assembly of the plural battery cells 70 sandwiched between the first bracket 33 and the second bracket 37 is further being sandwiched between the first shell 10 and the second shell 40, forming a battery set package with sandwich structure.

Moreover, each of the plural battery cells 70 is configured with a cylinder-shaped frame 70 of a specific length that has two terminals defined at the two opposite longitudinal ends of the frame 71. It is noted that the frame 71 is substantially a hard shell made of a rigid metal, such as stainless steel. In this embodiment, the anode electrode 72 and the cathode electrode 73 of each battery cell 70 are arranged on the same terminal, and the plural battery cells 70 are orientated for allowing the longitudinal directions of the frames 71 of the plural battery cells 70 to be parallel with each other, forming a battery set, so as to enable the terminals of all the battery cells where the anode and the cathode electrodes 72, 73 are arranged to face toward the same direction.

In addition, the first bracket 33 and the second bracket 37 are disposed respectively at the two opposite terminals of the plural battery cells 70, and each of the two brackets 33, 37 is configured with a first side and a second side that are opposite to each other, i.e. the first bracket 33 is configured with a first side 333 and a second side 334, while the second t bracket 37 is configured with a first side 373 and a second side 374. Thereby, in this embodiment, the terminals of all the battery cells 70 where the anode and the cathode electrodes 72, 73 are arranged are orientated facing toward the first side 333 of the first bracket 33 while allowing the terminals of all the battery cells 70 without any electrode to face toward the first side 373 of the second bracket 37. It is noted that the second sides 334, 374 of the first and the second brackets 33, 37 are not in contact with the plural battery cells 70. As shown in FIG. 1, there is a plurality of receptacle holes 331 formed on the first side 333 of the first bracket 33 in a manner that each of the receptacle holes 331 is formed penetrating the first bracket 33 and has a water-proof pad 36 disposed therein. It is noted that the pad 36 can be an O-ring, a water-proof flexible washer, or a coating of glue, and it is feasible to assembly a plurality of the water-proof pad 36 into a pad piece for facilitating the assembling of the brackets 33. Similarly, there is a plurality of receptacle holes 371 formed on the first side 373 of the second bracket 37 in a manner that the plural receptacle holes 371 are formed penetrating the second bracket 37 at positions corresponding the receptacle holes 331 formed on the first bracket 33. Thereby, the terminals of all the battery cells 70 where the anode and the cathode electrodes 72, 73 are arranged are inset into the receptacle holes 331 of the first bracket 33, while allowing the water-proof pads 36 to be sandwiched between the corresponding terminals and the receptacle holes 331, so that by the insulation provided by the water-proof pads 36, the battery cells 71 can be prevented from being damaged by the leaking of dust or moisture through the receptacle holes 331. Moreover, since the receptacle holes 331 of the first bracket 33 are located at positions corresponding to the receptacle holes 371 of the second bracket 37, the terminal of each battery cell 70 that is not configured with the anode and cathode electrodes 72, 73 can be inset into the corresponding receptacle holes 371 of the second bracket 37, consequently enabling the battery cells 70 to be fixedly secured between the first sides 333, 373 of the first and the second brackets 33, 37 while allowing the anode electrodes 72 and the cathode electrodes 73 to inset into the receptacle holes 331 of the first bracket 33. In addition, the first brackets 33 is configured with a bearer 332 at its second sides 334 in a manner that the bearer 332, being formed smaller than the corresponding first bracket 33 in size, is arranged protruding out of the second side 334 of the first bracket 33; and similarly, the second brackets 37 is configured with a bearer 372 at its second sides 374 in a manner that the bearer 372, being formed smaller than the corresponding second bracket 37 in size, is arranged protruding out of the second side 374 of the second bracket 37. In this embodiment, the bearer 332 is configured with a plurality of first connecting pieces 17, and each first connecting piece 17 is further configured with two electrode fixing holes 172 and one sensor fixing hole 171, in that the two electrode fixing holes 172 are provided for two neighboring battery cells 70 to embed therein in a manner that one of the two electrode fixing holes 172 is inset by the anode electrode 72 of one battery cell 70 while another electrode fixing hole 172 is inset by the cathode electrode 73 of another battery cell 70. By the screwing of nuts 16 on the external threads formed on the anode electrodes 72 and the cathode electrodes 73, each first connecting piece 17 can be fixedly secured for enabling the battery cells 70 to connect in series or in parallel with each other for achieving larger voltage output or current output. In this embodiment, the fifteen battery cells 70 is arranged in a 5×3 array.

In addition, there are two second connecting pieces 20a and 20b disposed on the bearer 332 to be used respectively as a main anode connector and a main cathode connector. As shown in FIG. 1, the second connecting pieces 20a is configured with two electrode fixing holes 21a in a manner that one of the two electrode fixing holes 21a is embedded by the cathode electrode 73 of one battery cell 70 that is series connected while allowing another electrode fixing hole 21a to be connected to an input joint 221 of a cable 22 by the use of fixture comprising a nut 24 and a blot 23, and thereby, the second connecting pieces 20a is acting as an anode input or output. Similarly, the second connecting pieces 20b is configured with two electrode fixing holes 21b in a manner that one of the two electrode fixing holes 21b is embedded by the anode electrode 72 of one battery cell 70 that is series connected while allowing another electrode fixing hole 21b to be connected to an input joint 271 of a cable 27 by the use of fixture comprising a nut 24 and a blot 23, and thereby, the second connecting pieces 20b is acting as a cathode input or output.

In this embodiment, each of the plural first connecting pieces 17 and the two second connecting pieces 20a, 20b is a one-piece metal conductive plate. However, they can be assembled into one large plate or a number of plates of different shapes, or they can be assembled and built as a circuitboard integrating all the series connection and parallel connection enabled by the plural first connecting pieces 17 and the two second connecting pieces 20a, 20b in a manner that they can be replaced by a piece of circuitboard for facilitating the assembling convenience of the present disclosure.

With the aforesaid configuration, the opposite terminals of all the battery cells 70 are fixed respectively to the first bracket 33 and the second bracket 37 and assembled with the plural first connecting pieces 17 and the two second connecting pieces 20a, 20b.

Moreover, any pair of two neighboring battery cells 70 that is parallel connected is coupled to at least one sensor 14 for monitoring the temperature of voltage value of the two neighboring battery cells 70. Accordingly, each of such sensor 14 is electrically connected to a circuitboard 25 by a signal line 141, while being fixed tightly by a fixture 15, which can be a blot in this embodiment, to one of the two electrode fixing holes 172 of a corresponding first connecting piece 17 that is connected to the pair of the battery cells 70, and thereby, the measurement of the temperature or voltage value from the sensor 14 can be transmitted to the circuitboard 25 for processing through the signal line 141. It is noted that the circuitboard 25 is fixed to the second side 334 of the first bracket 33 by the use of a clipping device or fastener. Thus, the processed signal of the circuitboard 25 is outputted through a first signal cable 29 and its signal joint 291 so as to be provided to an external battery management unit, by that not only the current temperature and voltage of each pair of parallel-connected battery cells 70 can be monitored in real time, but also the voltage variation of battery cells that are series connected can be calculated and thus obtained, so as to be used as basis for determining the timing of battery charging/discharging, or powering-off in view of battery protection.

After the assembling of the aforesaid parallel-series connection, the power output connection and the signal monitoring connection, the first shell 10 is then being placed covering on the bearer 332 of the first bracket 32 in a manner that the continuous flanges 11a˜11d that is formed at the periphery of a surface of the first shell 10 is orientated facing toward the first bracket 33 to be engaged surrounding the periphery of the bearer 332 of the first bracket 33. Thereby, an accommodation space can be formed between the first shell 10 and the bearer 332 that can be used for receiving the circuitboard 25, the first connecting pieces 17, and the second connecting pieces 20a, 20b. Moreover, there can be a water-proof pad 32 disposed surrounding the periphery of the bearer 332, and the water-proof pad 32 can be an O-ring, a water-proof flexible washer, or a coating of glue. By the insulation provided by the water-proof pads 32, dust or moisture can be prevented from leaking into the accommodation space formed between the first shell 10 and the first bracket 33. Similarly, the second shell 40 is being placed covering on the bearer 372 of the second bracket 37 in a manner that the continuous flanges 41a˜41d that is formed at the periphery of a surface of the second shell 40 is orientated facing toward the second bracket 37 to be engaged surrounding the periphery of the bearer 372 of the second bracket 37. It is noted that the first and the second shells 10, 40 are disposed respectively attaching to the surfaces of the first and the second brackets 33, 37 at are not in contact with the battery cells 710. Moreover, there can be a water-proof pad 32 disposed surrounding the periphery of the bearer 372, and the water-proof pad 32 can be an O-ring, a water-proof flexible washer, or a coating of glue. By the insulation provided by the water-proof pads 32, dust or moisture can be prevented from leaking into the accommodation space formed between the second shell 40 and the second bracket 37.

In addition, there are via holes 12a, 12b, 12c formed on the flanges 11b, 11d of the first shell 11 so as to be provided for enabling the anode cable 22, the cathode cable 27 and the signal cable 29 are all extending out of the first shell 10 and the first bracket 33 therethrough; and simultaneously, by configuring rubber blocks 223, 273, 292 respectively on the anode cable 22, the cathode cable 27 and the signal cable 29 while enabling those rubber blocks 223, 273, 292 to seal the via holes 12a, 12b, 12c when the first shell 10 is disposed covering the first bracket 33, not only the detaching and assembling of the anode cable 22, the cathode cable 27 and the signal cable 29 that are extending out of the e first shell 10 and the first bracket 33 can be performed easily, but also they can prevent dust or moisture from leaking into the space sandwiched between the first shell 10 and the first bracket 33 through those cables 22, 27, 29.

As shown in FIG. 1, there are a plurality of fixing lugs 13 disposed on the periphery of the first shell 10 and similarly there are a plurality of fixing lugs 42 disposed on the periphery of the second shell 40, whereas the fixing lugs 13 are disposed at positions corresponding to the fixing lugs 42 on the second shell 40. Each of the fixing lugs 13 is further configured with a fixing hole 131, and also each of the fixing lugs 42 is further configured with a fixing hole 421, by that a blot 50 can be disposed penetrating each pair of corresponding fixing lugs 13, 42 through their fixing holes 131, 421. It is noted that each blot 50 is designed to function in conjunction with a spacer 52 and a nut 51, in which each spacer 52, being formed as a tube-shape object with a specific length and an outer diameter larger than the inner diameters of both the fixing holes 131, 421, is designed to be sandwiched between the pair of corresponding fixing lugs 13, 42. As shown in FIG. 1, the bolt 50 is disposed in a manner that its axial direction is orientated parallel with the axial direction of the frame 71 of the battery cell 70. For assembling the battery set package 100 as the one shown in FIG. 2, each bolt 50 is first being mounted to the first shell 10 by penetrating the same through the corresponding fixing hole 131, and then after sheathing the same into the corresponding spacer 52, the blot 50 is bored to the second shell 40 through the corresponding fixing hole 421 so as to be screwed by the nut 51 while allowing the two terminals of the spacer 52 to abut against the opposite fixing lugs 13, 42. The purpose of the spacer 52 is to prevent the nut 51 from overscrewing into the blot 50, causing the pad 32 to be overly pressed. Although the tightly pressed pads 32 can ensure a satisfactory insulation to the battery set package 100, the pads 32 that are being tightly compressed for a long period of time can lost its insulation ability by an elastic fatigue phenomena. Thus, by forming each spacer 52 with a specific length, the two ends of the spacer 52 can abut respectively against the pair of corresponding fixing lugs 13, 42 when it is sandwich between the first shell 10 and the second shell 40, so that not only the stress resulting from the assembling during the screwing of the nuts 51 on the corresponding bolts 50 can be supported by the spacers 52, but also the first shell 10 can be spaced from the second shell 40 by a specific distance so as to prevent the pads 32 as well as the first shell 10 and the second shell 40 from being overly pressed. Consequently, the first shell 10 and the second shell 20 can be firmly assembled without causing any mechanical damage or mechanical internal stress to the internal components of the battery set package 100.

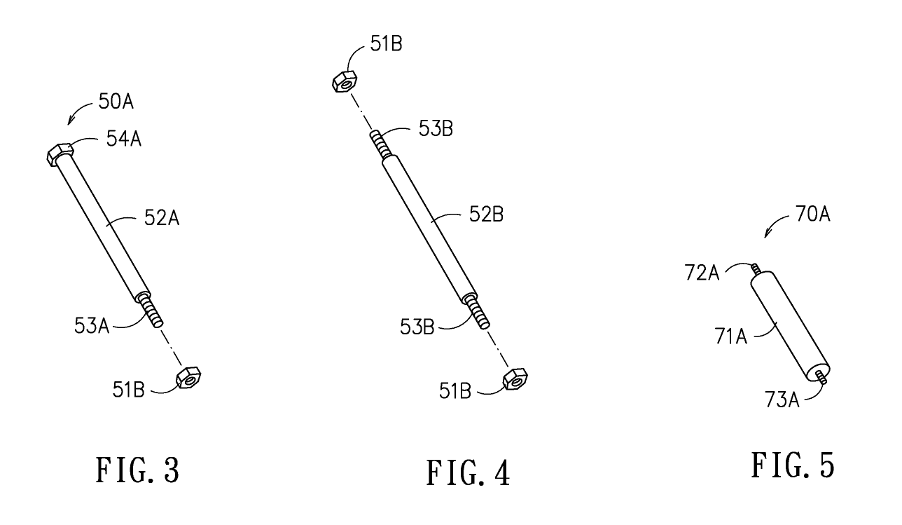

Please refer to FIG. 3, which is a schematic diagram showing a bolt used in the present disclosure that is capable of acting as a spacer. As shown in FIG. 3, the bolt 50A comprises a spacer section 52A, a thread section 53A and a bolt head 54A, in a manner that the blot head 54A is formed with an outer diameter larger than that of the spacer section 52A, while the space section 52A is formed with an outer diameter larger than that of the thread section 53A. Thereby, the bolt 50A is capable of acting as an equivalent to the assembly of the bolt 50 and the spacer 52, as the one shown in FIG. 2, which can be disposed boring through first the fixing hole 131 and then through another fixing hole 421, as shown in FIG. 1, so as to be screwed by the nut 51A, and thereby, the terminal of the spacer section 52A that is connected to the thread section 53A is abutted against the fixing lug 42 while allowing the bolt head 54A of the bolt 50A to abut against another fixing lug 13. In addition to the bolt 50A shown in the aforesaid embodiment, the spacer 52B that is shown in FIG. 4 can be adopted and used in the present disclosure. As shown in FIG. 4, the spacer 52B, being formed with a specific length that is extending in an axial direction, has two terminals defined at the two opposite longitudinal ends of the spacer, whereas each terminal is formed with a thread section 53B with an outer diameter smaller than that of the space 52B so as to be provided for a nut 51B to mount and screw thereat; and thereby, as the two shells 13, 42 are formed respectively with two fixing holes 131, 421 at positions corresponding to each other, the two terminals of the spacers 52B are capable of being disposed abutting against the shells 13, 42 at positions corresponding to the fixing holes 131, 421 when the two thread sections 53B are being inserted into the two fixing holes 131, 421 in respective. It is noted that the assembly of the bolt 50, the spacer 52 and the nut 51 of FIG. 1, the assembly of the nut 51A and the bolt 50A configured with the spacer section 52A and the thread section 53A of FIG. 3, and the assembly of the nut 51B and the bolt 50B having two thread sections 53B of FIG. 4 are all embodiments of a fixtures for exerting a clamping force upon the first shell 10 and the second shell 40. To sum up, the purpose of the fixtures is to exert clamping forces in a direction parallel with the longitudinal direction of the frame 71 to the two shells 10, 40 so as to press the two shells 10, 40 to move toward each other and thus fixedly secured the two brackets 33, 37 along with the plural battery cells 70 between the two shells 10, 40.

It is noted that the anode electrode 72 and the cathode electrode 73 of each battery cell 70 shown in the first embodiment of FIG. 1 are all being disposed at the same end of the battery's frame 71, which is a common configuration adopted by most commercial lithium batteries available today, and moreover, in addition to the cylinder-shaped frame 71 shown in FIG. 1, the frame can be shaped as a bar with rectangle cross section. However, in addition to the battery cells 70 shown in FIG. 1, the battery cells can adopted other configurations, such as the battery cells 70A shown in FIG. 5. As shown in FIG. 5, each battery cell 70A is configured with an anode electrode 72A and a cathode electrode 73A that are arranged respectively at the two opposite terminals of its frame 71A, and each anode electrode 72 as well as the cathode electrode 73A is formed with a thread for facilitating the same to connect to other joints by screwing. In a situation that the battery cells to be packed inside to battery set package of the present disclosure are the battery cells 70A shown in FIG. 5, each receptacle hole 371 of the second bracket 37 shown in FIG. 1 should also be padded with a water-poof pad 36 therein. It is noted that the pad 36 can be an O-ring, a water-proof flexible washer, or a coating of glue. Similarly, in addition to the cylinder-shaped frame 71 shown in FIG. 1, the frame can be shaped as a bar with rectangle cross section. Moreover, when the frame 70 of each battery cell 70 of FIG. 1 as well as the frame 71A of each battery cell 70A shown in FIG. 5 are shaped as a bar with rectangle cross section, the receptacle holes 331, 371 of FIG. 1 should also be formed as rectangle-shaped holes.

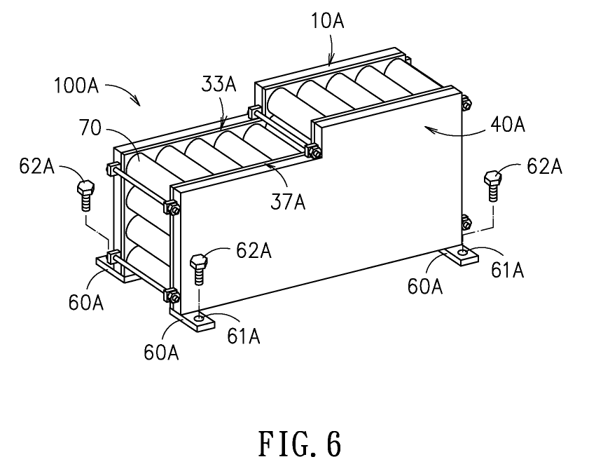

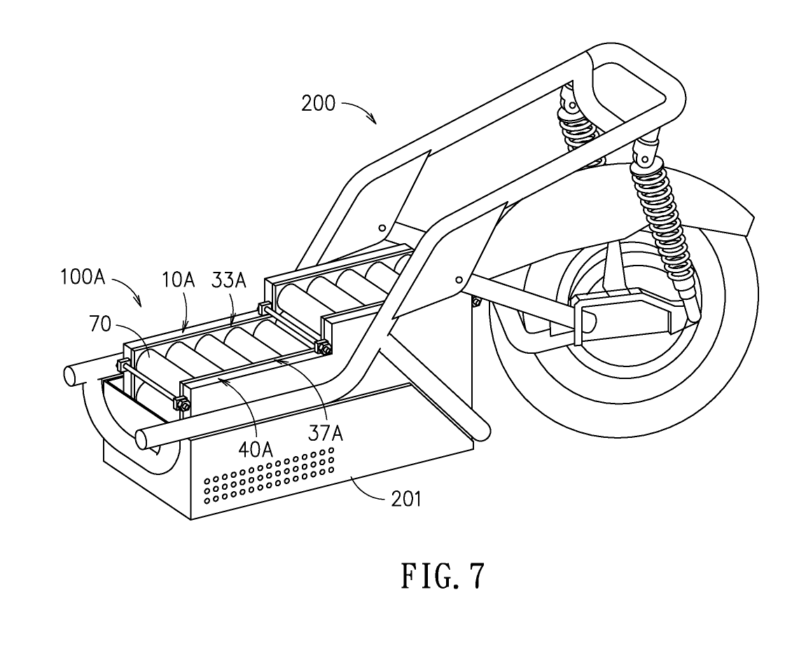

Please refer to FIG. 6 and FIG. 7, which show a battery set package according to another embodiment of the present disclosure. As shown in FIG. 6 and FIG. 7, the battery set package 100A comprises a plurality of battery cells 70, a first bracket 33A, a second bracket 37A, a first shell 10A and a second shell 40A. It is noted that in addition to the battery cells 70, the battery cells 70A can also be used in this embodiment. Moreover, the battery set package 100A is an irregular-shaped object that is so-constructed for conforming to the space available in a vehicle frame that is provided for the battery set package 100A to install. In FIG. 6, the battery set package 100A is configured with a plurality of fixing plates 60A, each having a fixing hole 61A formed thereat so as to be provided for a bolt 62A to bore therethrough. By boring the blots 62A through their corresponding fixing holes 61A, the battery set package 100A can be fixedly mounted to a vehicle frame 200. As shown in FIG. 7, there can be a protective cap 201 mounted at the bottom of the vehicle frame 200 for preventing the battery set package 100A from being hit by pebbles that are stirred up by the moving of the vehicle. It is known that a moving vehicle will cause a powerful flow of air, and the nature flow of air is generally more effective than the miniature-sized fan used in a forced-air cooling device for lowering the temperature of the operating battery cells in the battery cell package 100A. It is noted that the battery set package of the present disclosure not only is suitable for electric vehicles, but also can be adapted for any electric-powered means, such as electric boats. In addition, the first shell 10A and the second shell 40A can be made from sheet metal parts, and that is also true for the first and the second shells 10, 40 of FIG. 1. As the first shell 10A is assembled with the second shell 40A in a manner that the receive areas of the two shells 10A, 40A are orientated facing toward each other for packing all the other components inside the space sandwiched between the two shells 10A, 40A, the so-constructed battery set package 100A is a rigid object with sandwich structure. In addition, by configuring the pads 32, 36, as those shown in FIG. 1, into the battery set package 100A with sandwich structure, the battery set package 100A can have good water-proof, dust-proof and shirt-circuit protection abilities, not to mention that the battery set package 100A is advantageous for its simple structure, easy to detach and good cooling performance by nature wind. When the battery set package 100A is mounted on the vehicle frame 200, the strength of the first shell 10A as well as that of the second shell 40A are both being enhanced as the battery set package 100A can be integrated into the vehicle frame 200, so that the components packed inside the battery set package 100A are capable of withstanding even larger collision or inertial forces due to the acceleration or deceleration of the vehicle. Moreover, there is no restriction relating to the orientation of the battery set package 100A. For instance, the battery cells 70 inside the battery set package 100A shown in FIG. 7 are disposed transverse to the vehicle frame 200, however, the orientation of the battery cells 70 can be rotated by 90 degrees if required for enabling the battery cells 70 to be disposed vertically without having any adverse affect to the rigidity of the battery set package 100A or its cooling performance by nature air convection.

To sum up, the rigidity of the battery set package of the present disclosure is insured not only by its outer shells that are made of stainless steel for example, but also by the packing of a battery set that comprises a conceivable amount of battery cells so as to be used as its structural parts. That is, by screw bolting the fixtures on the shells of the battery set package for enabling the two shells to press tightly respectively on the opposite terminals of each battery cell packed inside the battery set package, each battery cell inside the battery set that is packed inside the battery set package is used as one load-supporting structural part of the battery set package. Thereby, in addition to the making of the shells from stainless steel for example, the more battery cells to be packed inside the battery set package, the better the rigidity of the battery set package will have. Thus, the battery set package can be built with less structural parts, and thus other than the battery cells, the weight and volume of the battery set package can be reduced but still rigid enough to be mounted on a vehicle frame for withstanding any collision. Moreover, since the battery cells mounted inside the package are exposed and thus can be cooled down by air flows of natural convection, especially when the battery set package is mounted on a vehicle, the battery cells can be fully cooled down by the wind resulting from the moving of the vehicle without requiring additional cooling device, and consequently, the weight of the complete battery set package can be greatly reduced with comparatively smaller space required for installment, and the probability of malfunction is greatly reduced as well as the manufacturing cost is greatly reduced.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A battery set package, comprising:
a plurality of battery cells, each being configured with a frame of a specific length that has two terminals defined at the two opposite longitudinal ends of the frame;
two brackets, each being configured with a first side and a second side that are opposite to each other, the two brackets being disposed respectively at the two opposite terminals of the frame for allowing the plural battery cells to be sandwiched between the two first sides of the two brackets;
two shells, respectively mounted on the second sides of the two brackets while allowing the two bracket having the plural battery cells sandwiched therebetween to be sandwiched between the two shells; and
a plurality of fixtures, for exerting clamping forces in a direction parallel with the longitudinal direction of the frame to the two shells so as to press the two shells to move toward each other and thus fixedly secured the two brackets along with the plural battery cells between the two shells.

2. The battery set package of claim 1, wherein each fixture comprises: a bolt, being configured with an external thread and a bolt head whose outer diameter is larger than that of the bolt, and a nut; and thereby, as the two shells are formed respectively with two fixing holes at positions corresponding to each other, each bolt is disposed penetrating one of the two sells through the corresponding fixing hole and then out of another fixing hole on another shell so as to be screwed with the nut while enabling the axial direction of the blot to parallel with the longitudinal direction of the frame.

3. The battery set package of claim 2, wherein each fixture further comprises: a spacer, being formed as a tube-shape object with an outer diameter larger than the outer diameter of the external thread of the corresponding bolt.

4. The battery set package of claim 1, wherein each fixture comprises: a bolt, being configured with a spacer section, a thread section and a bolt head in a manner that the blot head is formed with an outer diameter larger than that of the spacer section, while the space section is formed with an outer diameter larger than that of the thread section.

5. The battery set package of claim 1, wherein each fixture further comprises: a spacer, being formed with a specific length, having two terminals defined at the two opposite longitudinal ends of the spacer, and each terminal is formed with a thread section with an outer diameter smaller than that of the space so as to be provided for a nut to mount and screw thereat; and thereby, as the two shells are formed respectively with two fixing holes at positions corresponding to each other, the two terminals of the spacers are capable of being disposed abutting against the shells at positions corresponding to the fixing holes when the two thread sections are being inserted into the two fixing holes in respective.

6. The battery set package of claim 1, wherein each of the two brackets is formed with a plurality of receptacle holes in a manner that each of the plural receptacle holes of one of the two brackets is arranged corresponding to one receptacle hole on another bracket for allowing the two terminals of the frame of one corresponding battery cell to inset therein in respective.

7. The battery set package of claim 6, wherein each battery cell is configured with an anode electrode and a cathode electrode that are arranged at one terminal selected from the two opposite terminals of its frame, and the plural battery cells are orientated for allowing the longitudinal directions of the plural battery cells to be parallel with each other so as to enable the terminals of all the battery cells where the anode and the cathode electrodes are arranged to face toward the same bracket and inset into their corresponding receptacle holes while using water-proof pads that are fitted inside those receptacle holes for preventing dust as well as moisture to from leaking the corresponding battery cells.

8. The battery set package of claim 6, wherein each battery cell is configured with an anode electrode and a cathode electrode that are arranged respectively at the two opposite terminals of its frame while being inset into the corresponding receptacle holes of the two brackets, and simultaneously, using water-proof pads that are fitted inside the plural receptacle holes of the two brackets for preventing dust as well as moisture from leaking into the corresponding battery cells.

9. The battery set package of claim 1, wherein each of the two brackets is configured with a bearer at its second side in a manner that the bearer, being formed smaller than the corresponding bracket in size, is arranged protruding out of the second side; and each of the two shells is further configured with continuous flanges at the periphery of a surface of the corresponding shell that is facing toward its corresponding bracket while allowing each shell to cover on its corresponding bracket for enabling the continuous flanges to engage surrounding the periphery of the bearer of the corresponding bracket.

10. The battery set package of claim 9, wherein there are water-proof pads respectively mounted on the bearers of the two brackets to be used for preventing dust as well as moisture from leaking into spaces sandwiched between the shells and their corresponding brackets.

11. A battery set package, adapted for packing a plurality of battery cells, each being configured with a frame of a specific length that has two terminals defined at the two opposite longitudinal ends of the frame, the battery set package comprising:
two brackets, each being configured with a first side and a second side that are opposite to each other, the two brackets being disposed respectively at the two opposite terminals of the frame for allowing the plural battery cells to be sandwiched between the two first sides of the two brackets;
two shells, respectively mounted on the second sides of the two brackets while allowing the two bracket having the plural battery cells sandwiched therebetween to be sandwiched between the two shells; and
a plurality of fixtures, for exerting clamping forces in a direction parallel with the longitudinal direction of the frame to the two shells so as to press the two shells to move toward each other and thus fixedly secured the two brackets along with the plural battery cells between the two shells.
